(19) United States
(12) Patent Application Publication
(10) Pub. No.: US 2006/0012487 A1
(43) Pub. Date: Jan. 19, 2006

(54) Traffic control sign assembly

(76) Inventors: Thomas W. Gibson, Rockford, IL (US); Todd M. Gibson, Algonquin, IL (US)

Correspondence Address: MERONI + MERONI, P.O. BOX 309, BARRINGTON, IL, 60011, US

(21) Appl. No.: 11/192,659

(22) Filed: Jul. 29, 2005

Related U.S. Application Data
(63) Continuation-in-part of application No. 11/062,727, filed on Feb. 22, 2005.
(60) Provisional application No. 60/588,324, filed on Jul. 16, 2004.

(51) Int. Cl. G08B 5/22; G08G 1/095

(52) U.S. Cl. 340/815.45; 340/908

(57) ABSTRACT

The present invention provides a vehicle signal light assembly comprising a two-sided sign assembly composed of cooperatively opposite sign structures each having a central opening defined therein, an inner sign structure surface, and an outer sign structure surface. The central openings are defined by a light panel-receiving framework at the inner sign structure surfaces and by opposed diffusing panel-receiving frameworks at the outer sign structure surfaces. The light panel-receiving framework frames a two-sided light emitting diode (LED) light panel, the LED lights of which are exposed by the central opening. The light panel is thus sandwiched between the cooperating sign structures within the light panel-receiving framework. Light diffusing panels are received in the opposing diffusing panel-receiving frameworks. Light emitting from the LED's thus passes through the central opening and is diffused by the opposed light diffusing panels.

### PRIOR HISTORY

This application is a continuation-in-part patent application claiming the benefit of pending non-provisional U.S. patent application Ser. No. 11/062,727, filed in the United States Patent and Trademark Office on Feb. 22, 2005, which application is a non-provisional patent application claiming priority to provisional U.S. Patent Application No. 60/588,324, filed in the United States Patent and Trademark Office on Jul. 16, 2004.

### BACKGROUND OF THE INVENTION

1. Field of the Invention

The present invention generally relates to vehicular traffic safety devices. More particularly, the present invention relates to vehicular traffic signaling lights and signs and specifically discloses a traffic control sign assembly.

2. Description of the Related Art

Traffic control devices have been used in many applications for decades. Such devices range from hand-held signs to traffic signs and lights. Applications vary and include school crossings, construction sites, airports, roadside emergencies, trucking usages, emergency equipment and so forth. These devices are used to alert the public and oncoming traffic of potential safety issues and are also used to protect those located at the locations at issue. Many devices have been prepared and used for these applications; however none of these devices, to the knowledge of the inventors, provide protection and warning to oncoming traffic at such distance and with such coverage as with the present invention hereafter disclosed.

Existing devices, such as the Illuminated Traffic Sign of U.S. Pat. No. 6,198,410 B1, which issued to White et al., disclose an illuminatable traffic sign that is secured to a post and has indicia disposed thereon and a plurality of lights positioned along an outer periphery and along the indicia. However, the White apparatus does not appear to teach the light enhancement and coverage concepts of the present invention and the lights used in the White apparatus only appear to be as effective as their individual wattages.

In like manner, U.S. Pat. No. 6,029,382 which issued to Kochanowski, discloses a Reflective Sign that includes a face member that has a plurality of cube corners disposed along a back surface for light reflection. However, the '382 device relies upon reflection of oncoming light and does not provide an enhanced lighted sign assembly that can be seen at dusk or night without the use of lights in oncoming vehicles, flashlights, and the like.

Other patented sign devices including those of U.S. Pat. Nos. 6,009,650; 6,422,714 B1; 5,276,424; 6,409,358 B1; 6,407,675 B1; and 6,239,691 B1 provided lighted sign devices. However, none provide the enhanced visual clarity, brightness, and coverage features needed to warn oncoming traffic and the public from distances as far away as ¼ mile and in a 170 degree line of sight from the center of the sign. It is therefore important and necessary that a traffic control sign assembly be developed that provides enhanced visual clarity, brightness, and coverage including up to distances of at least ¼ mile and at nearly any angle from which the sign can be turned. The traffic control sign assembly must be highly visible, distinctly display the appropriate warning messages, capable of quickly being powered by various means, sturdy, lightweight, adaptable to different sites and under different working conditions, and be easy to use and manufacture.

Other objects of my invention, as well as particular features, elements, and advantages thereof, will be elucidated in, or apparent from, the following description and the accompanying drawing figures.

### SUMMARY OF THE INVENTION

The present invention provides a vehicle signal light assembly comprising a two-sided sign assembly composed of cooperatively opposite sign structures each having a central opening defined therein, an inner sign structure surface, and an outer sign structure surface. The central openings are defined by a light panel-receiving framework at the inner sign structure surfaces and by opposed diffusing panel-receiving frameworks at the outer sign structure surfaces. The light panel-receiving framework frames a two-sided light emitting diode (LED) light panel, the LED lights of which are exposed by the central opening. The light panel is thus sandwiched between the cooperating sign structures within the light panel-receiving framework. Light diffusing panels are received in the opposing diffusing panel-receiving frameworks. Light emitting from the LED's thus passes through the central opening and is diffused by the opposed light diffusing panels.

The light panel is powered by a power source such as electrochemical batteries, which batteries are located in inferior adjacency to the sign structures. Switch means selectively enable the user to power the light panel and optionally may function to provide a constant power source (for providing a constant illuminated signal) or to provide a periodic power source (for providing a flashing illuminated signal). Further, fastening means function to connect the sign structures to each other in unitary assembly.

A legend-bearing screen or sign is positioned intermediate each light diffusing panel and the light panel, each of which bear a traffic control signifier, such as “STOP” or “SLOW”. A handle assembly may be secured to the outer perimeter of the sign structures for enabling the traffic control sign assembly to be hand held by a person.

In another embodiment, a vehicle signal light assembly is provided, which vehicle signal light assembly is designed to be hand held, pole (telescopically) assisted, or hands-free stand-mounted, and comprises a flat plate sized and shaped in the form of a traffic sign that has a central opening defined by an annular sign rim. A control console structure is secured in centered relation in said central opening and is peripherally bounded by said annular rim. A two-sided bread board type LED light panel is mounted in said control console structure and diffused or prismatic panels are mounted on opposite sides of said control console structure on opposite sides of said central opening. Batteries are mounted on an underside of said control console structure and are connected to said two-sided bread board type LED light panel thus providing electrical power to light said two-sided bread board type LED light panel. Means connecting said control console structure internally and to said sign in unitary assembly are provided. A first silk screen with a traffic legend on back of one of said diffused or prismatic panels is mounted in said control console structure while a second silk screen with another traffic legend on back of another of said diffused or prismatic panels is mounted on an opposite side of said control console structure. Switch means for turning said batteries “ON” in a holding or a flashing mode and for turning said batteries “OFF” is also provided.

In still another embodiment, the present invention provides a traffic control sign assembly comprising a sign having a central opening defining an annular sign rim and opposing sides. A control console is positioned on each opposing side of said sign in centered relation to said central opening and means connecting said control consoles to said sign and to each other in unitary assembly are provided. A double-sided light panel (optionally mirrored) having LED's is mounted on opposing surfaces and is centrally located in said connected control consoles. A prismatic panel is centrally mounted in each control console over each opposing surface of said optionally mirrored double-sided LED light panel and said central opening. A power source is electrically connected to said double-sided LED light panel and a handle assembly is secured to said sign for supporting said sign.

Finally, in another embodiment, the present invention provides a traffic control sign assembly kit. The kit essentially comprises: a traffic sign (assembly); a modular handle assembly or telescoping pole assembly; a power source (e.g. batteries, an inverter and cord, vehicular cigarette lighter cord, external battery cord); various accessories; and a carrying case. Said traffic sign assembly comprises a traffic sign having a central opening defining an annular sign rim and opposing sides. A control console is positioned on each opposing side of said traffic sign in centered relation to said central opening. Means connecting said control consoles to said traffic sign and to each other in unitary assembly are provided. A dual-sided LED light panel (optionally mirrored) is centrally located within said connected control consoles and a prismatic panel is centrally mounted in each control console over the optionally mirrored, dual-sided LED light panel and the central opening. The power source is electrically connected to the optionally mirrored LED light panel and the modular handle or telescopic pole assembly and includes screwed-in attachment means for constructing and for securing the modular handle or telescopic pole assembly to itself and to said traffic sign. The carrying case is provided for containing the traffic sign (assembly); the modular handle assembly or telescoping pole assembly; the power source (e.g. batteries, an inverter and cord, vehicular cigarette lighter cord, external battery cord); and various other accessories as may be required.

The present invention therefore provides a traffic control sign assembly that provides enhanced visual clarity, brightness, and coverage including distances of at least ¼ mile and at nearly any angle from which the sign can be turned. The traffic control sign assembly is highly visible, distinctly displays the appropriate warning messages, is capable of quickly being powered by various means and is sturdy, lightweight, adaptable to different sites and under different working conditions, and is easy to use and manufacture.

### DESCRIPTION OF THE DRAWINGS

Other features of our invention will become more evident from a consideration of the following brief description of our patent drawings, as follows:

FIG. 1 is a fragmentary top perspective view of the traffic control sign assembly in an assembled state showing a first handle assembly.

FIG. 2 is a fragmentary exploded perspective view of the traffic control sign assembly.

FIG. 3 is a front plan view of the sign of the traffic control assembly.

FIG. 4 is an edge view of the sign shown in FIG. 3.

FIG. 5 is a front plan view of one control console of the traffic control sign assembly.

FIG. 6 is a side plan view of one control console of the traffic control sign assembly.

FIG. 7(a) is a plan view of a first side of a first prismatic panel of the traffic control sign bearing the legend, “STOP”.

FIG. 7(b) is an edge view of a first two-sided bread board type LED light panel of the traffic control sign assembly.

FIG. 7(c) is a plan view of the second side of the first prismatic panel shown in FIG. 7(a) bearing the legend, “SLOW”.

FIG. 8(a) is a plan view of a first side of a second prismatic panel of the traffic control sign bearing the legend, “STOP”.

FIG. 8(b) is an edge view of a second two-sided bread board type LED light panel of the traffic control sign assembly.

FIG. 8(c) is a plan view of the second side of the second prismatic panel shown in FIG. 8(a) bearing the legend, “STOP”.

FIG. 9 is a fragmentary enlarged plan view of a second preferred traffic control sign assembly bearing no legend upon the prismatic panel and a second handle assembly.

FIG. 10 is a fragmentary edge view of the traffic control sign assembly shown in FIG. 9.

FIG. 11 is a fragmentary reduced plan view of the traffic control sign assembly shown in FIG. 9.

FIG. 12 is a fragmentary enlarged cross-sectional view of the traffic control sign assembly as taken from FIG. 11, showing a two-sided bread board type LED light panel and surrounding structures.

FIG. 13 is a fragmentary enlarged view of the structures otherwise shown in FIG. 12.

FIG. 14 is a fragmentary cross-sectional view of a portion of a third traffic control assembly, showing two one-sided bread board type LED light panels and surrounding structures.

FIG. 15 is a fragmentary enlarged plan view of a fourth preferred traffic control sign assembly bearing no legend upon the prismatic panel and showing the first handle assembly.

FIG. 15(a) is a fragmentary edge view of the traffic control sign assembly shown in FIG. 15.

FIG. 15(b) is a fragmentary cross-sectional view of the traffic control sign assembly as taken from FIG. 15.

FIG. 15(c) is a depiction of a battery compartment of the traffic control sign assembly shown in FIG. 15.

FIG. 16 is a fragmentary plan view of the fourth preferred traffic control sign assembly showing one control console.

FIG. 17 is a fragmentary side plan view of the fourth preferred traffic control sign assembly showing two control consoles.

FIG. 18 is a plan view of a bread board type LED light panel showing a series of edge molding structures exploded from the light panel.

FIG. 18(a) is an end view of one edge molding structure as shown in FIG. 18.

FIG. 18(b) is a fragmentary end view of the edge molding structure shown in FIG. 18(a) attached to an upper edge of the light panel shown in FIG. 18.

FIG. 19 is a circuit diagram diagrammatically depicting certain electrical circuitry of the traffic control sign assembly.

FIG. 20(a) is a comparative plan view of a first side of the traffic control sign assembly bearing the legends, “STOP-STOP”.

FIG. 20(b) is a comparative plan view of a first side of the traffic control sign assembly bearing the legends, “STOP-SLOW”.

FIG. 20(c) is a comparative plan view of a first side of the traffic control sign assembly bearing the legends, “SLOW-SLOW”.

FIG. 21 is a front view of a stand-mounted traffic control sign assembly.

FIG. 22 is a fragmentary top perspective view of the traffic control sign assembly in an assembled state showing a first handle assembly and optional reflective materials upon the prismatic panels.

FIG. 23 is a fragmentary bottom perspective view of the traffic control sign assembly in an assembled state showing switch means and low-battery alert means.

FIG. 24 is a fragmentary bottom perspective view of a preferred alternative embodiment of the traffic control sign assembly in an exploded state showing first and second sign assemblies, a handle, and a grip.

FIG. 25 is a fragmentary exploded perspective view of the preferred alternative embodiment of the traffic control sign assembly.

FIG. 26 is a fragmentary enlarged plan view of a first side of the preferred alternative embodiment bearing the legend “SLOW” upon a prismatic panel and a third handle assembly.

FIG. 27 is a fragmentary exploded edge view of the preferred alternative embodiment of the traffic control sign assembly shown in FIG. 26.

FIG. 28 is a fragmentary enlarged plan view of a second side of the preferred alternative embodiment bearing the legend “STO . . . ” [STOP] upon a prismatic panel and the third handle assembly.

FIG. 29 is a circuit diagram diagrammatically depicting certain electrical circuitry of the preferred alternative embodiment of the traffic control sign assembly.

FIG. 30 is a plan view of a battery box and adjacent structure of the preferred alternative embodiment of the traffic control sign assembly.

FIG. 31 is a top diagrammatic view of light-emitting faces of the traffic control sign assemblies depicting the potential viewing range of the traffic control sign assemblies.

### DETAILED DESCRIPTION OF THE PREFERRED EMBODIMENT(S)

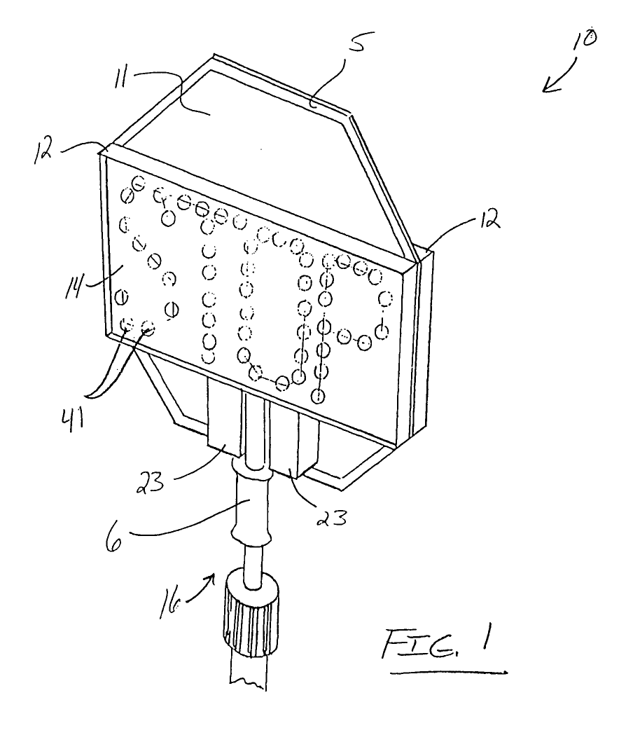

Referring now to the drawings, the present invention concerns a traffic control sign assembly, also known as a traffic control sign assembly or a vehicle signal light assembly. A preferred embodiment of the traffic control sign assembly is illustrated and generally referenced at 10 in FIGS. 1, 2, 22, and 23. A preferred alternative embodiment of the traffic control sign assembly is illustrated and generally referenced at 80 in FIGS. 24-28. It is contemplated that traffic control sign assemblies 10 and 80 are to be particularly used in various settings and circumstances to warn oncoming motorists and people of safety and emergency issues. In this last regard, by way of example, it is contemplated that traffic control sign assemblies 10 and/or 80 may be used in situational scenarios such as at school, construction, industrial, fire safety, law enforcement, and at emergency sites. As previously discussed above under the section entitled, BACKGROUND OF THE INVENTION, from a safety standpoint, it is very important to provide a traffic control sign assembly that provides enhanced visual clarity, brightness, and coverage including distances of at least ¼ mile and at nearly any angle from which the sign can be turned. Thus, it is contemplated that traffic control sign assemblies 10 and/or 80 must be highly visible, distinctly display the appropriate warning messages, be capable of quickly being powered by various means, be sturdy, lightweight, adaptable to different sites and under different working conditions, and be easy to use and manufacture. The present invention as embodied in traffic control sign assemblies 10 and/or 80 provides these key features and further satisfies these needs. It is not intended that the present invention be limited solely to the specifics disclosed, rather it is intended that the scope of the present invention also include other traffic control sign devices and the like.

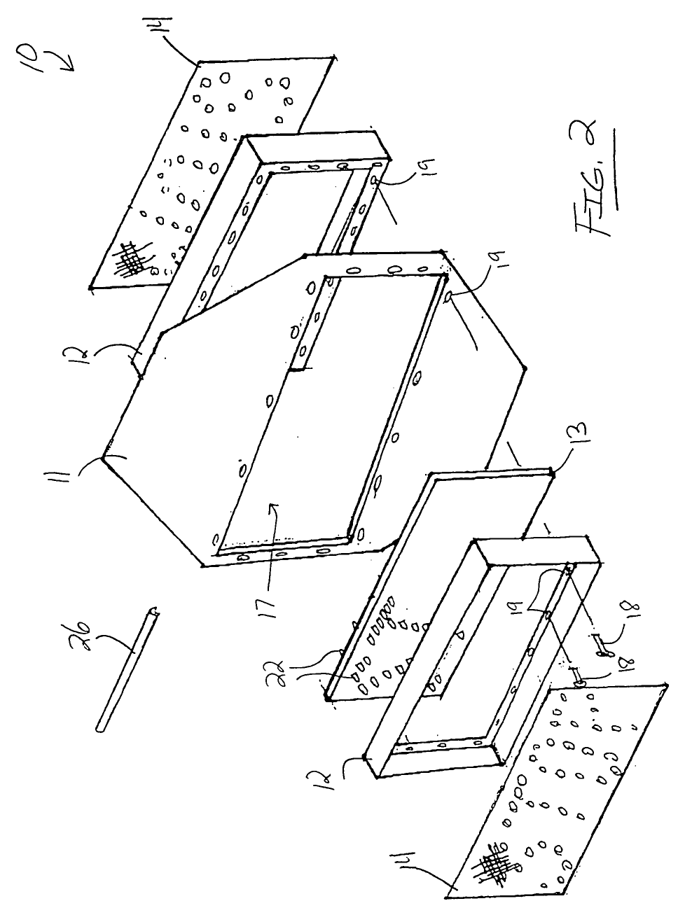

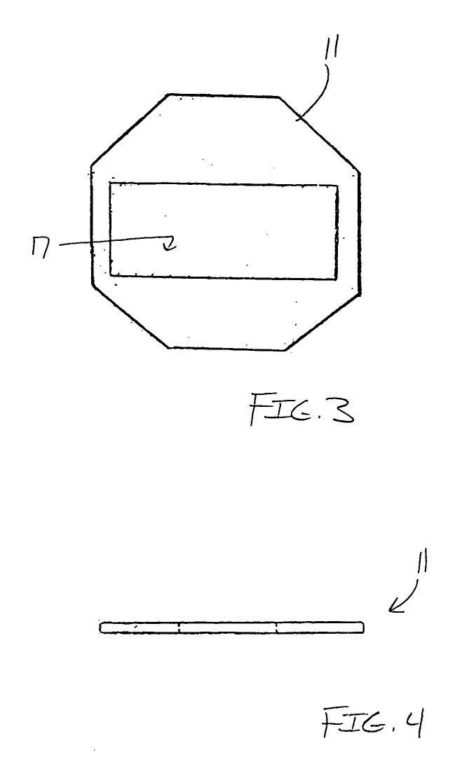

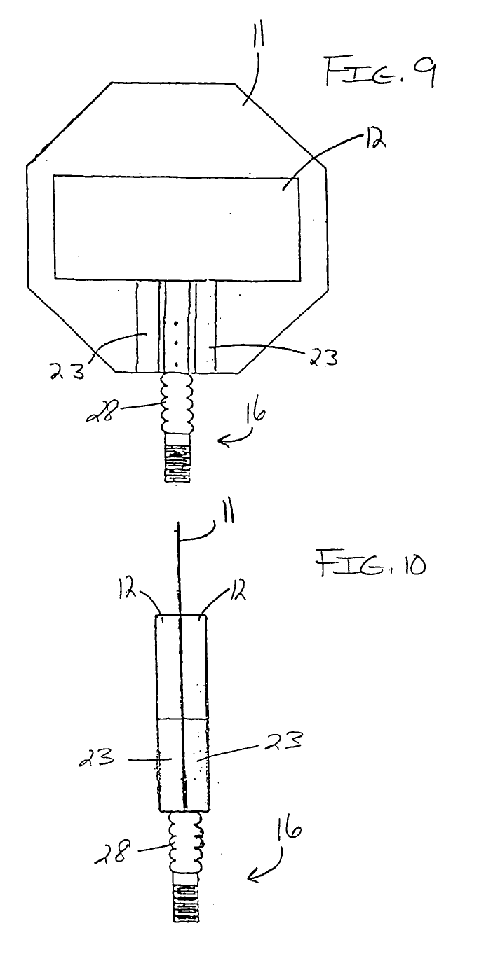

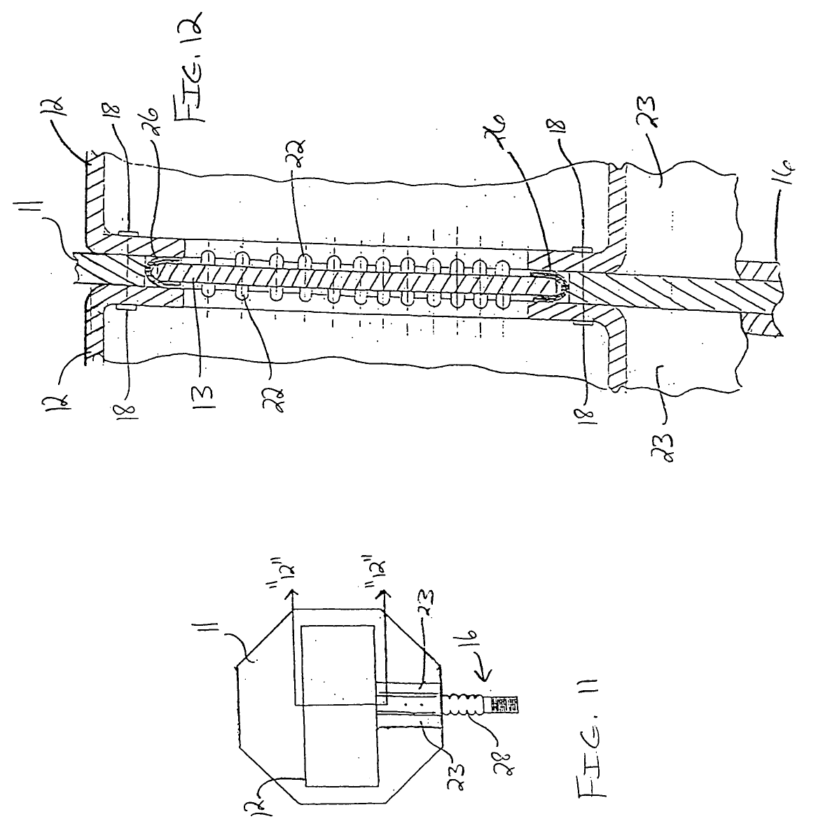

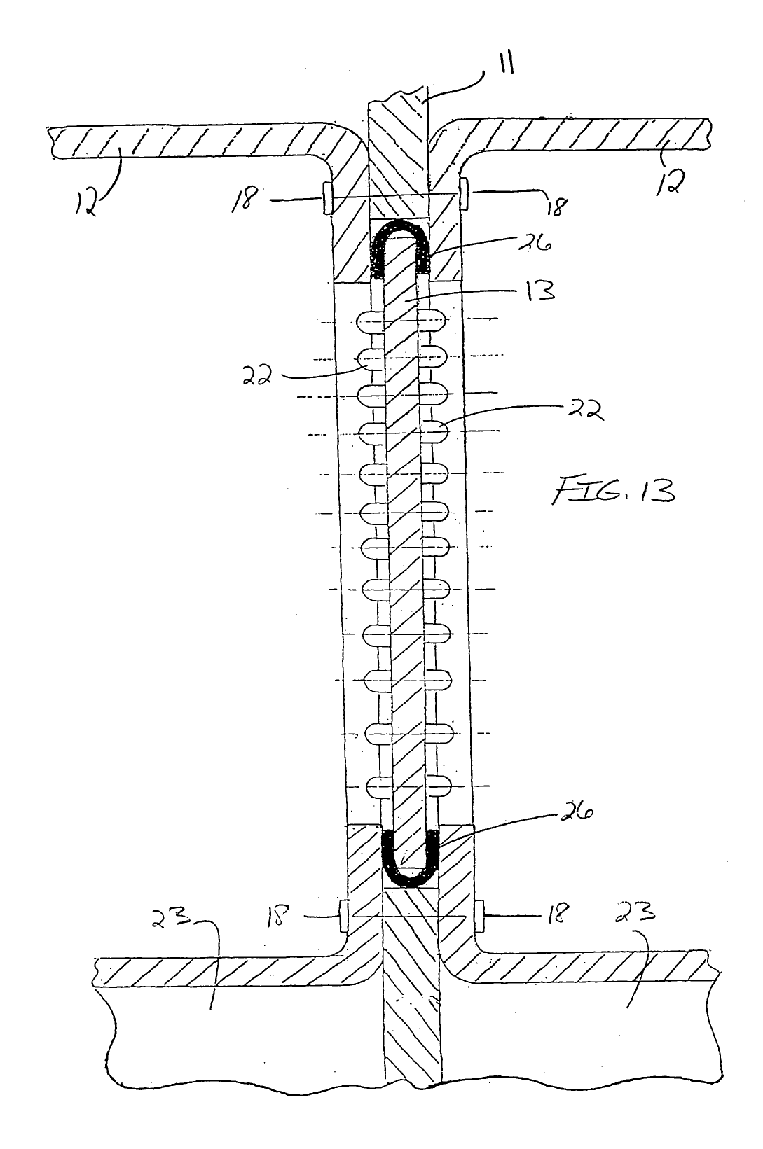

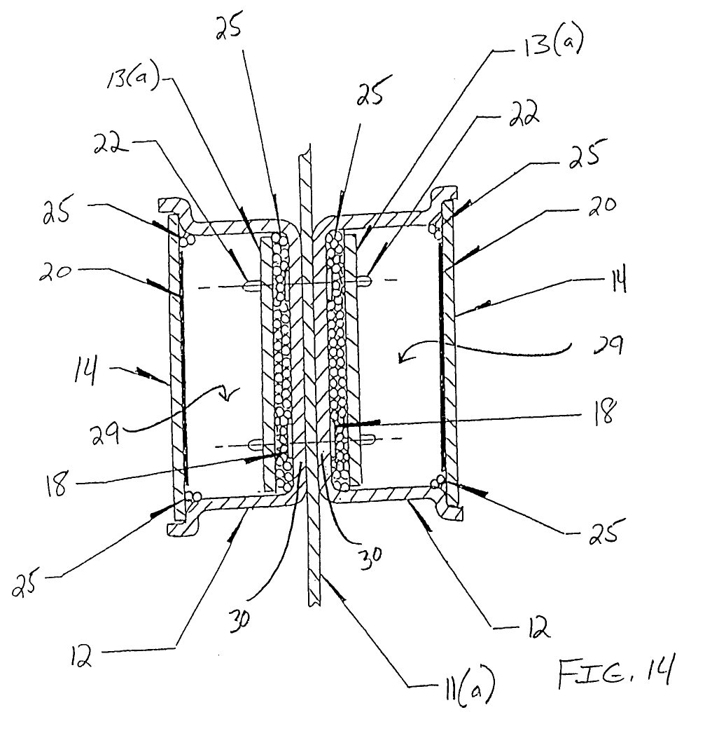

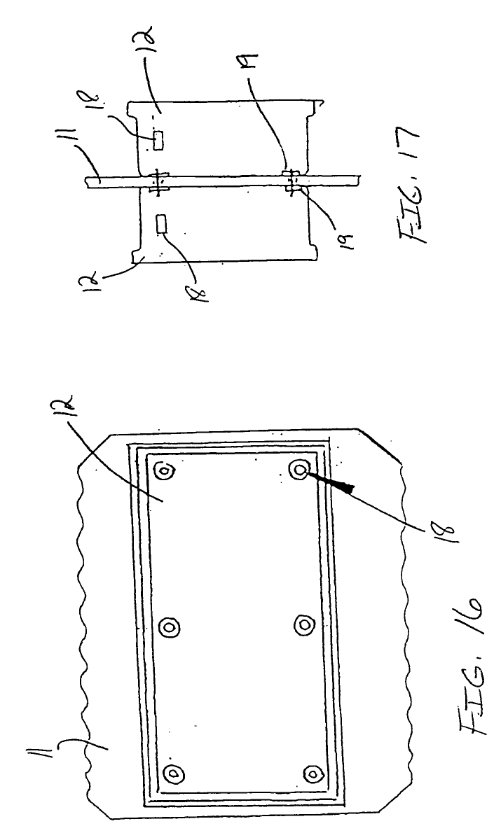

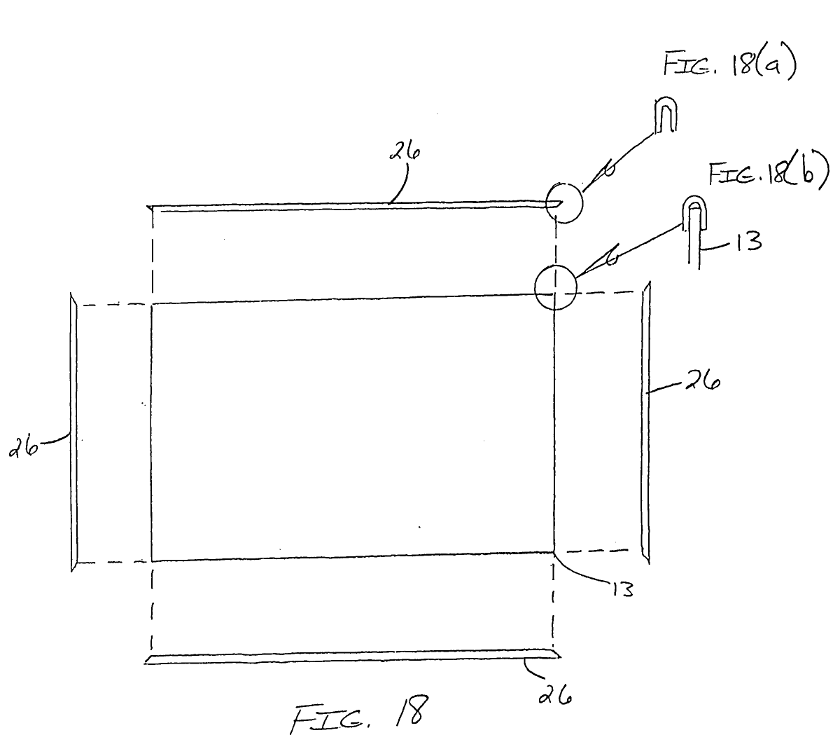

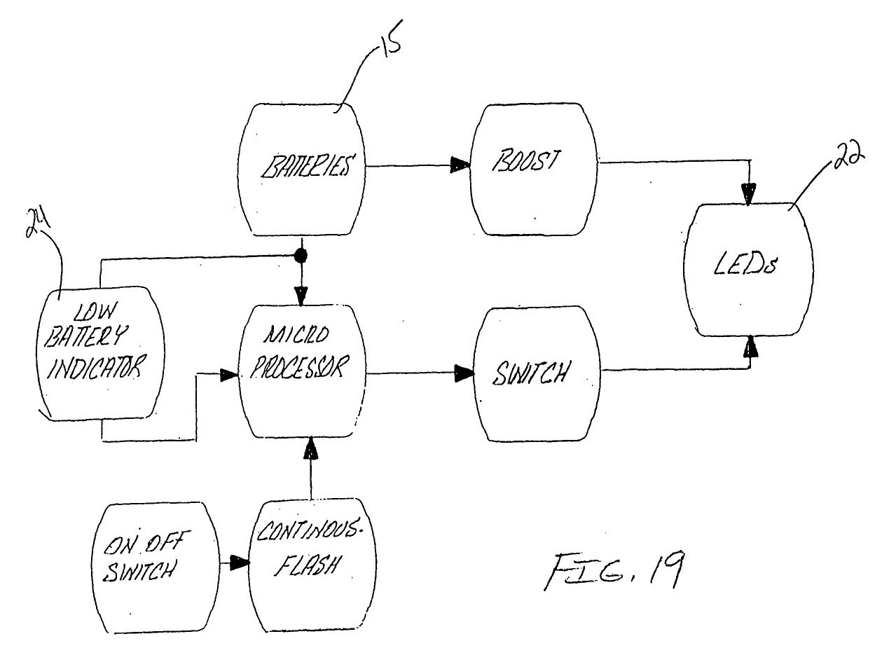

A first preferred embodiment of the present invention is illustrated in FIGS. 1 and 2, namely, a traffic control sign assembly 10 or vehicle signal light assembly. It will be seen from an inspection of FIGS. 1 and 22 that (glass bead type) reflective tape 5 can be mounted on edges of both sides of said traffic sign for increased visibility of said traffic sign. Traffic control sign assembly 10 preferably comprises a sign 11 as is illustrated and referenced in FIGS. 1-4, 9-13, 15, 15(a), 15(b), 16, and 17; a pair of control consoles 12 as illustrated and referenced in FIGS. 1, 2, 5, 6, 9-15(b), 16, and 17; a two-sided bread board type LED light panel 13 as illustrated and referenced in FIGS. 2, 7(b), 8(b), 12, 13, 25, and 27; light-diffusing (diffused or prismatic) panels 14 as illustrated and referenced in FIGS. 2, 7(a), 7(c), 8(a), 8(c), 14, 24, 25, and 27; batteries 15 as illustrated and referenced in FIGS. 15(c) and 19; means connecting control consoles 12 to sign 11 and each other in unitary assembly; first and second silk screens 20 as illustrated and referenced in FIG. 14; switch means; and a handle assembly 16 as generally illustrated and referenced in FIGS. 1, 9-12, 15, 15(a), 24-28, and 30.

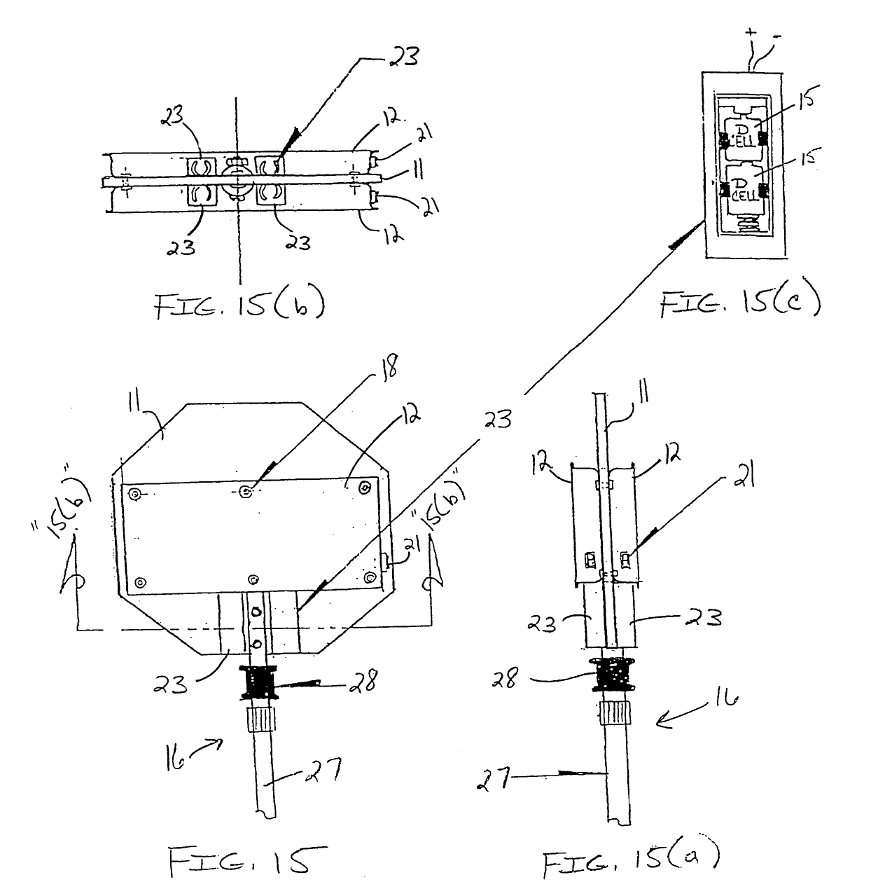

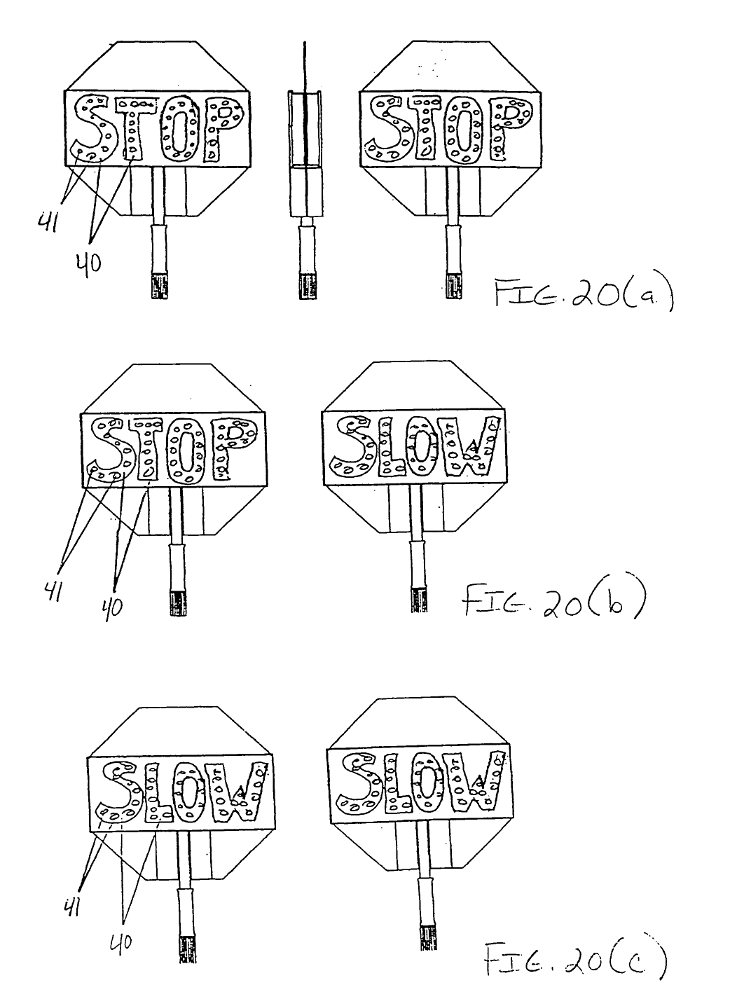

Sign 11 preferably comprises a central opening 17 as generally referenced in FIGS. 2 and 3. It will be understood from an inspection of the noted figures that central opening 17 is preferably defined by an annular sign rim. It will be further understood from a consideration of the noted figures that control consoles 12 are preferably positioned on opposite sides of sign 11 and are preferably in centered relation to central opening 17. Light panel 13 is preferably mounted in central opening 17 in sandwiched relation between control consoles 12. Diffused or prismatic panels 14 are preferably mounted in control consoles 12 in central alignment on opposite sides of central opening 17. Batteries 15 are preferably mounted on an underside of control consoles 12 and connected to two-sided bread board type LED light panel 13, thus providing electrical power to light two-sided bread board type LED light panel 13. The means connecting control consoles 12 to sign 11 and each other in unitary assembly may preferably be defined by rivets 18 and rivet-receiving structure 19 as both are illustrated and referenced in FIG. 2. Rivets 18 are further referenced in FIGS. 12-15, 16 (6 rivets 18), and 17. Rivet-receiving structures (apertures) 19 are further referenced in FIGS. 5 and 17. It will be seen from a comparative inspection of the noted figures that the number of rivets 18 and corresponding rivet-receiving structures 19 may vary depending on the application.

In one embodiment, first silk screen 20 bearing the legend “STOP” appears on back of one of diffused or prismatic panels 14 is mounted in one of control consoles 12 and second silk screen 20 with bearing the legend “STOP” or “SLOW” appears on back of another of diffused or prismatic panels 14 mounted in another of control consoles 12. The switch means, designed for turning batteries 15 “ON” in a holding or a flashing mode and for turning batteries 15 “OFF” have been generally referenced at 21 in FIGS. 15, 15(a), and 15(b). Handle assembly 16 is preferably secured to sign 11 for enabling sign 11 to be hand held by a person.

Thus, traffic control sign assembly 10 preferably comprises sign 11 having central opening 17 that is defined by an annular sign rim. Sign 11 can be octagon shaped, such as for a standard stop sign, as has been generally illustrated in the noted figures for ease of illustration, or sign 11 can be shaped as deemed necessary, it being noted that signs take on various shapes and sizes. In addition, sign 11 can be painted with reflective paint or have reflective tape, such as glass bead type reflective tape, attached to its surface and edges to enhance the display of the message. For example, a red color can be used for a “STOP” message and orange for “SLOW” and these colors can be painted to conform with standard shapes as used in traffic laws, such as octagonal for stop and triangular for yield and so forth. Moreover, sign 11 may be silk screened to enhance the messages displayed and the size and presentation of the sign is intended to meet all federal, state, and local codes. It is also intended that these features apply to both sides of sign 11 as it is dual-sided as explained in more detail below.

The pair of control consoles 12 is preferably positioned on opposite sides of sign 11 and in centered relation to central opening 17. Control consoles 12 are central to housing certain lights and circuitry of the present invention. It is contemplated that control consoles 12, and other parts to this invention are constructed of light-weight plastic, such as standard ABS, using injection or vacuum molding processes as are standard in the industry. Moreover, these and other parts are light-weight and the traffic control sign assembly 10 itself is intended to weigh approximately 5 pounds or less including batteries 15 and the like so that it may be easily held or supported by a person.

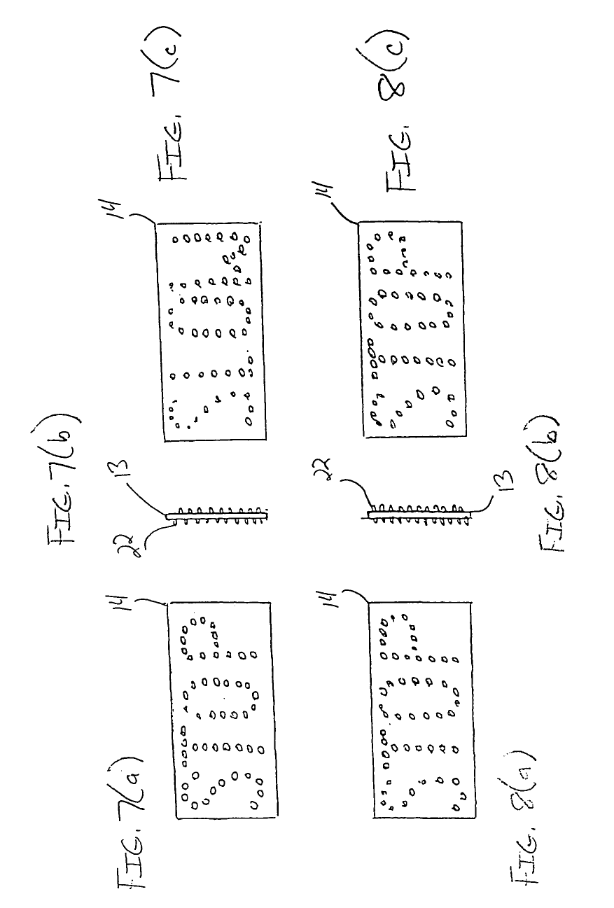

A further key feature of the present invention is two-sided bread board type LED light panel 13. Light panel 13 is preferably mounted in central opening 17 in sandwiched relation between control consoles 12. Light panel 13 is preferably a rectangular-shaped, double-sided, printed circuit board. Optionally, light panel 13 may comprise or be constructed of a mirror type material so as to increase its brightness and reflection capabilities. Light panel 13 is also known in the art as a bread board. In one embodiment, light panel 13 comprises LED lights 22 as illustrated and referenced in FIGS. 2, 7, 8, 12, 13, 14, and 19. LED lights 22 are preferably placed or surface mounted upon the circuit board to form or print the message that traffic control sign assembly 10 will state to oncoming traffic and people. LED lights 22 are preferably high-intensity lights and may be colored as deemed effective for the usage and situation. In a preferred embodiment, LED lights 22 are placed on each side of light panel 13 to form a legend or message on each side of light panel 13 so that an appropriate traffic control message will be communicated simultaneously to oncoming traffic on both sides of traffic control sign assembly 10. In a preferred embodiment, the legend(s), message(s), or advisories printed by LED lights 22 is/are “STOP” and “SLOW” as may be seen from a general inspection of FIG. 7. In this last regard, it is contemplated that traffic control sign assembly 10 may either state (on opposite assembly sides) “STOP-STOP” (as is generally depicted in FIG. 8) or “STOP-SLOW” for safety and traffic control purposes, such as would be the case at an accident, in construction zones, or at a school crossing scene.

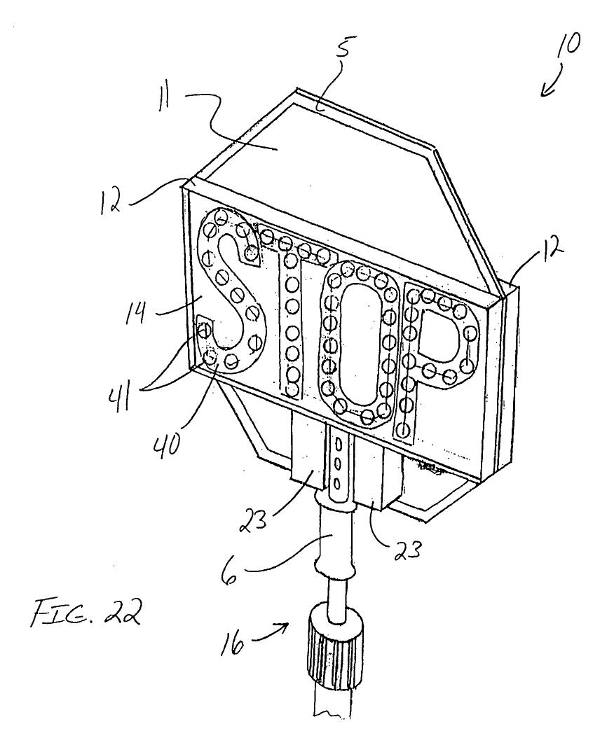

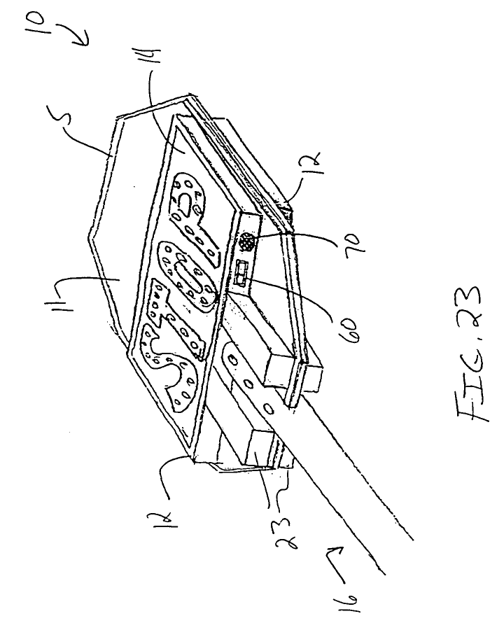

FIG. 20(a) depicts a further rendering of a “STOP-STOP” advisory; FIG. 20(b) depicts a further rendering of a “STOP-SLOW” advisory; and FIG. 20(c) depicts a rendering of a “SLOW-SLOW” advisory, all of which advisories represent common or typical advisories. It is contemplated that other advisories may easily be rendered upon the sign with appropriate adjustments. It will be seen from an inspection of FIGS. 20(a) through 20(c), that the present invention may further comprise reflective materials (paint or tape) 40 formed adjacent LED lights 22 so that a reflective material advisory appears in tandem with the LED light advisory. LED lights 22 are designed to shine through round apertures 41 as further referenced in FIGS. 1, and 20(a) through 20(c). It will thus be understood that advisories or legends may be painted with reflective materials with round apertures 41 for allowing light emanating from LED lights 22 to pass therethrough. Thus, the user may provide warnings or advisories even if the LED lighting turned off or otherwise inoperative. Reflective materials 40 and round apertures 41 are further illustrated and referenced in FIG. 22.

In other embodiments, light panel 13 could include a plurality of LED lights 22 and could be programmable so that the message(s) programmed will light up only the appropriate LED lights 22 to display the message. For illustration purposes only, the word, “STOP” uses 57 pixels and the word “SLOW” uses 63 pixels—the number of pixels varying depending upon the diameter of the pixels. Moreover, in particular where the messages are programmed, an additional feature is a microprocessor chip capable of holding messages in memory to preserve messages and/or to continue to display messages on traffic control sign assembly 10 even when the main power source (i.e. battery 15 and the like) expire.

Other key features of the present invention are diffused or prismatic panels 14, or prismatic panels as they are known in other embodiments. Diffused or prismatic panels 14 are preferably mounted in each control console 12 in central alignment on opposite sides of central opening 17. Diffused or prismatic panels 14 are preferably prismatic, meaning that they spread or diffuse light energy. Diffused or prismatic panels 14 thus preferably provide a cover for one side of the respective control console 12 and two-sided bread board type LED light panel 13.

In a preferred embodiment, first silk screen 20 bears the legend “STOP” and is located on the back of one of diffused or prismatic panels 14; further, second silk screen 20 bears the either the legend “STOP” or the legend “SLOW” and is located on the back of the other of diffused or prismatic panels 14. These silk screen legends are then aligned with LED lights 22 so that the spread of the light thereby increases the brightness and clarity of the message. The alignment and usage of the diffused (prismatic) panels 14 increases the distance from which the message can be easily read at least ¼ mile from traffic control sign assembly 10 and the angle of view of light panel 13 so that the message can be read from up to a 170 degree line of sight from the center of sign 11.

The ability to read the message from practically any orientation of traffic control sign assembly 10 dramatically increases the effectiveness of traffic control sign assembly 10 and practically overcomes any error in orientation of traffic control sign assembly 10 in the field, such as when the holder has accidentally turned planar portions of traffic control sign assembly 10 somewhat away from oncoming traffic. As discussed above, the messages on both sides of traffic control sign assembly 10 can then be read and understood at nearly all angles and from a large distance, thus improving protection of both the reader and the holder and people at the site at issue. Diffused or prismatic panels 14 are preferably constructed from phenolic type material (i.e. a type of reflective sheet covering) including pyramid type cones (i.e. dimpled) upon a surface thereof to deflect the light in all directions and to spread the light to enhance and equalize the brightness within the “pixel-looking” circles.

A power source, such as batteries 15 in a preferred embodiment, are mounted (i.e. preferably horizontally) on an underside of control consoles 12 in battery or power source compartments 23 as are illustrated and referenced in FIGS. 1, 9-13, and 15-15(c) and are connected to two-sided bread board type LED light panel 13 for providing electrical power to light two-sided bread board type LED light panel 13. In addition, it is contemplated that a low battery sound indicator 24 as referenced in FIG. 19 and automatic shut-off/shut-down of two-sided bread board type LED light panel 13 are provided as added features of the present invention. It is contemplated that other power sources, such as solar power and external power, may be utilized to power certain electric circuitry contained in traffic control sign assembly 10.

For example, it is contemplated that the present invention provides means for converting and using power from a source such as the cigarette lighter of any vehicle (e.g. an emergency vehicle) using a standard power inverter or from an external battery pack, which pack may be included in a traffic control sign assembly kit, as described in more detail hereinafter. In addition, the battery-powered power source can include battery packs (i.e. venus type), the preferred embodiment being two D-size cell battery packs with one pack for each side of the LED lights, and other larger 8-battery packs being used to increase battery life for traffic control sign assembly 10. The battery pack can also be recharged whether by direct plug-in cord adaptor with standard voltage ratings or by removal of the battery pack from traffic control sign assembly 10 and placement on a standard charger.

It should be noted (by way of example) that the control console may be plugged into any of the following external power sources: any vehicular cigarette lighter (12V direct current) by utilizing a power converter assembly (provided separately or provided with the traffic control sign assembly kit); any vehicle with a generator (e.g. emergency vehicles) supplying alternate current by utilizing a power inverter assembly (provided separately or provided with the traffic control sign assembly kit); or a standard external battery pack consisting of up to 16 batteries for longer life of LED lights 22.

As earlier stated, in order to make traffic control sign assembly 10 sturdy and practical for field use, the present invention makes use of means for connecting control consoles 12 to sign 11 and each other in unitary assembly. Said means may be further defined by comprising silicone glue fastening means 25 (referenced in FIG. 14) so as to keep components from “shearing off” if traffic control sign assembly 10 is otherwise dropped or jarred and further for keeping the unit water tight and usable in all weather conditions. In other words, it is contemplated that the silicone adhesive, having shock absorbing and weather barrier type properties may effectively function to prevent damage to components experiencing rapid accelerative forces (as by being dropped or jarred) and for enabling use of the vehicle signal light assembly in all weather conditions (as during rainy conditions).

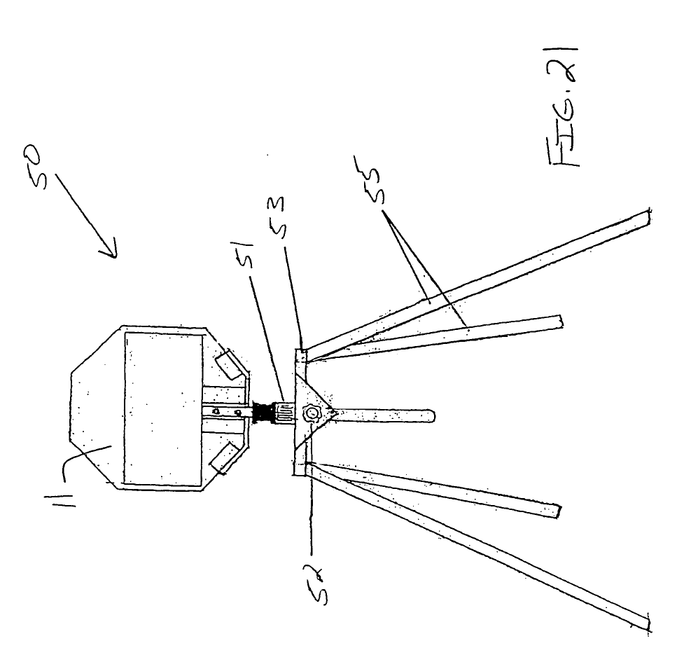

In addition, various spacers, insulating materials, connectors and standoffs are used as needed. In this regard, it is contemplated that a rubber type edge molding 26 is placed around the entire light panel 13 prior to insertion into central opening 17 to strengthen the attachment therein and to secure light panel 13 in case traffic control sign assembly 10 is bumped or dropped. Edge molding 26 is illustrated and referenced in FIGS. 2, 12, 13, and 18.

Another important feature of the present invention is switch means, shown at 21 in FIGS. 15 and 15(a), preferably defined by three-way selector switch means in a preferred embodiment. The switch means operate to activate the power source between “OFF”, continuous on, and flashing sequence modes so that the power source can then operate each set LED lights 22 on the opposing surfaces of traffic control sign assembly 10 independently and in any of the various modes. A preferred flashing sequence includes five flashes of LED lights 22 followed by 2 to 15 seconds where LED lights 22 are continuously on. Other flashing sequences can be programmed as needed. A generalized circuitry drawing is included as FIG. 19. The continuous ON and flashing modes, for example, coact with the diffused or prismatic panel structure so as to enable traffic control sign assembly 10 to be seen up to over ¼ of a mile before the headlights of on-coming vehicles hit the standard reflective signs and to give the holder of traffic control sign assembly 10 far greater safety in being seen. In another embodiment, the present invention also contemplates the usage of a strobe light located atop the sign for additional protection of the user and to draw further attention to the message.

An additional significant feature of the present invention, as generally referenced in FIGS. 9-12, 15, and 15(a), is handle assembly 16. Handle assembly 16 is preferably secured to sign 11 for enabling traffic control sign assembly 10 to be hand held by a person, in a preferred embodiment. Handle assembly 16 preferably includes different embodiments including a telescoping handle 27 as illustrated and referenced in FIGS. 15, 15(a), 25, and 30. Handle 27 preferably comprises screw means for screwed-in attachment and detachment means, a collapsible tripod embodiment for hands-free use, a modular or multi-sectioned handle that has screw attachment means, and a weighted base self-supporting stanchion embodiment that rests upon the ground. Handle assembly 16 may further preferably comprise a slide-on grip 28 as illustrated and referenced in FIGS. 9, 10, 11, 15, and 15(a) and telescoping handle 27 can extend traffic control sign assembly 10 to over 6 feet high for better message visibility. Handle assembly 16 may preferably be constructed from wood, plastic, or metal materials, and may be slotted so as to be received and yoked or interlocked with the sign. It should be noted that handle assembly 16 should be of sufficient weight so that traffic control sign assembly 10, in total, weigh approximately 5 pounds or less. Although not shown, other usages contemplated for the sign can include attachment to vehicles, such as school buses.

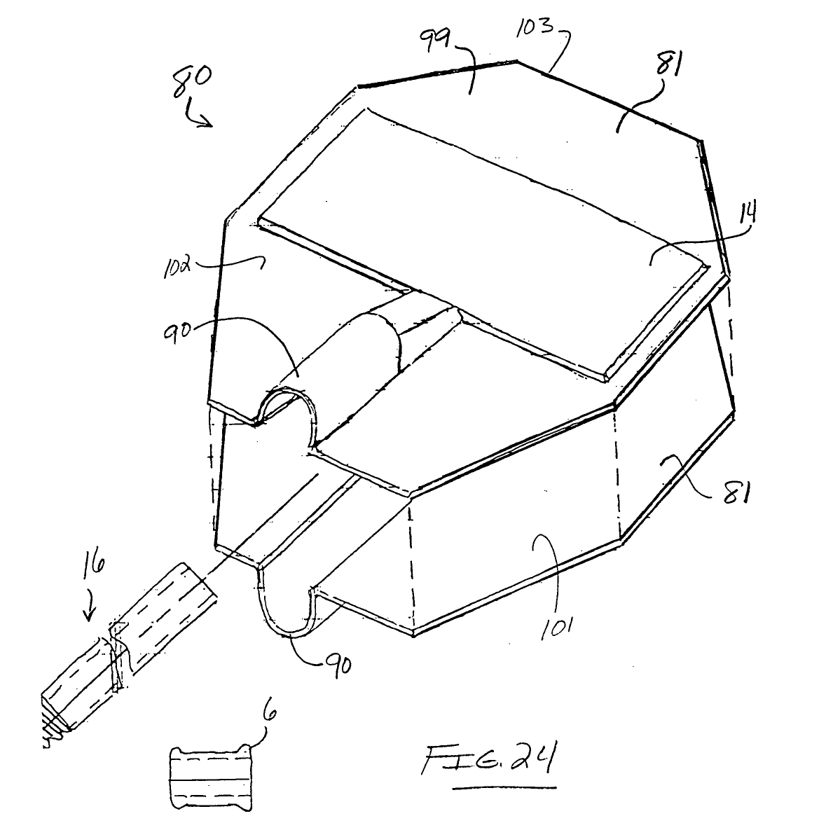

Further, it is contemplated that a hands-free, stand-mounted traffic control sign assembly 50 (as may be seen from an inspection of FIG. 21) may enable the user to temporarily situate the sign assembly so that the user may be free to perform other activities (other than holding sign assembly 10). From an inspection of FIG. 21, it will be seen that stand-mounted traffic control sign assembly 50 preferably comprises sign 11; a threaded sleeve 51; a locking knob 52; a tripod or four-legged stand 53; and a telescoping pole 54. Threaded sleeve 51 threads up onto base of the handle. The tripod or four-legged stand 53 may preferably comprise foldable legs 55 for portability. Telescoping pole 54 is designed for height adjustment as does locking knob 52. Note that the same telescoping pole may be utilized for the hand-held traffic control sign assembly or the stand-mounted traffic control sign assembly. With regard to the hand-held version, it is contemplated that a grip 6 (as referenced in FIGS. 1, 22, and 24-28) may be utilized in combination with handle assembly 16 to provide the holder with more comfortable structure with which to grasp and hold traffic control sign assembly 10.

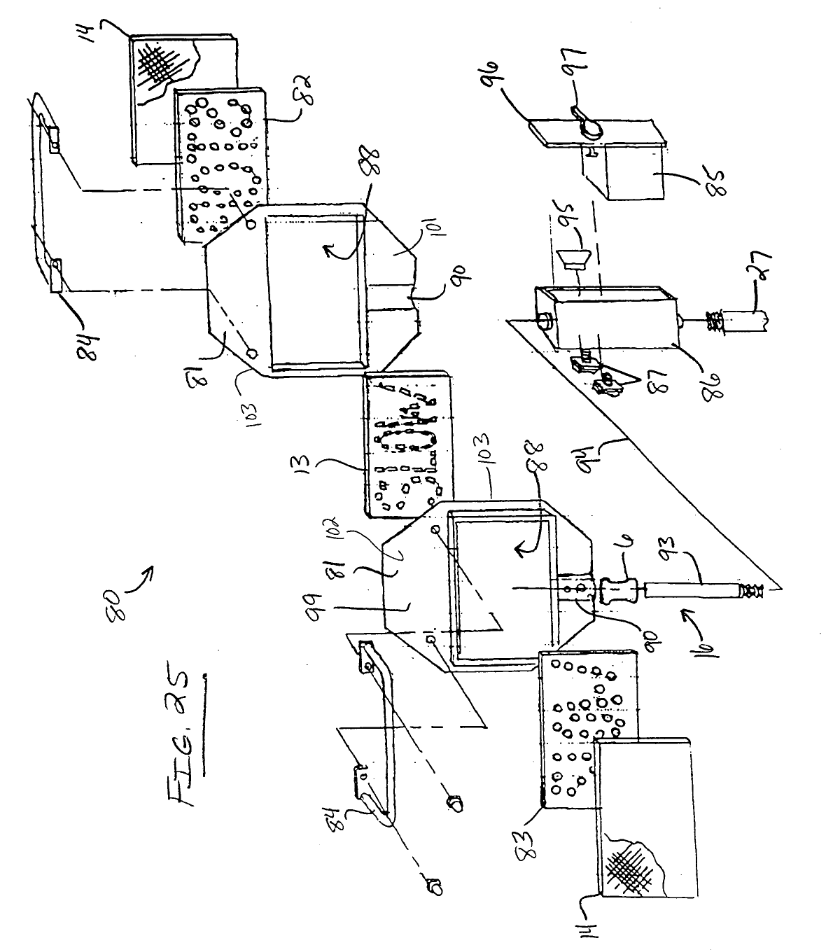

FIG. 23 is a fragmentary bottom perspective view of traffic control sign assembly 10 showing switch means 60 and low battery alert means 70. Low battery alert means 70 may be defined by electronically enabled audio means for alerting users to a low battery power state or visual means for alerting users to a low battery power state. Switch means 60 function to provide an OFF, an ON, or a FLASHING (i.e. alternating OFF-ON) LED light condition as desired by the user. It is contemplated that switch means 60 and low-battery alert means 70 are preferably located on the underside or inferior side of one control console 12 with enabling circuitry disposed internal to the sign assembly.

Finally, in another embodiment, a traffic control sign assembly kit is provided. As earlier indicated, the kit essentially comprises: a traffic sign (assembly); a modular handle assembly or telescoping pole assembly; a power source (e.g. batteries, an inverter and cord, vehicular cigarette lighter cord, external battery cord); various accessories; and a carrying case. Thus, the kit preferably comprises sign 11; modular handle assembly or telescoping pole assembly 16; a power source; and a carrying case (not specifically illustrated). Traffic sign 11, as described above, comprises central opening 17 defining an annular sign rim and opposing sides; control consoles 12 may be positioned on each opposing side of traffic sign 11 in centered relation to central opening 17; means connecting control consoles 12 to traffic sign 11 and to each other in unitary assembly; an optionally mirrored, dual-sided LED light panel 13 centrally located within the connected control consoles 12; and a prismatic panel 14 centrally mounted in each control console 12 over the optionally mirrored, dual-sided LED light panel 13 and central opening 17. The power source is electrically connected to the optionally mirrored LED light panel 13 and modular handle assembly 16, which assembly 16 includes screwed-in attachment means for constructing and for securing modular handle assembly 16 to itself and to traffic sign 11. The carrying case is provided for containing the traffic sign (assembly); the modular handle assembly or telescoping pole assembly; the power source (e.g. batteries, an inverter and cord, vehicular cigarette lighter cord, external battery cord); and various other accessories as may be required. The carrying case is sized for carrying traffic sign 11, the power source, and modular handle assembly or telescopic pole assembly 16 in detached form and is preferably constructed of vinyl or plastic materials.

In construction and in use the present invention therefore provides traffic control sign assembly 10 that provides enhanced visual clarity, brightness, and coverage including up to distances of at least ¼ mile and at nearly any angle from which traffic control sign assembly 10 can be turned. Traffic control sign assembly 10 is highly visible, distinctly displays the appropriate warning messages, is capable of quickly being powered by various means, and is sturdy, lightweight, adaptable to different sites and under different working conditions, and is easy to use and manufacture.

### PREFERRED ALTERNATIVE EMBODIMENT(S)

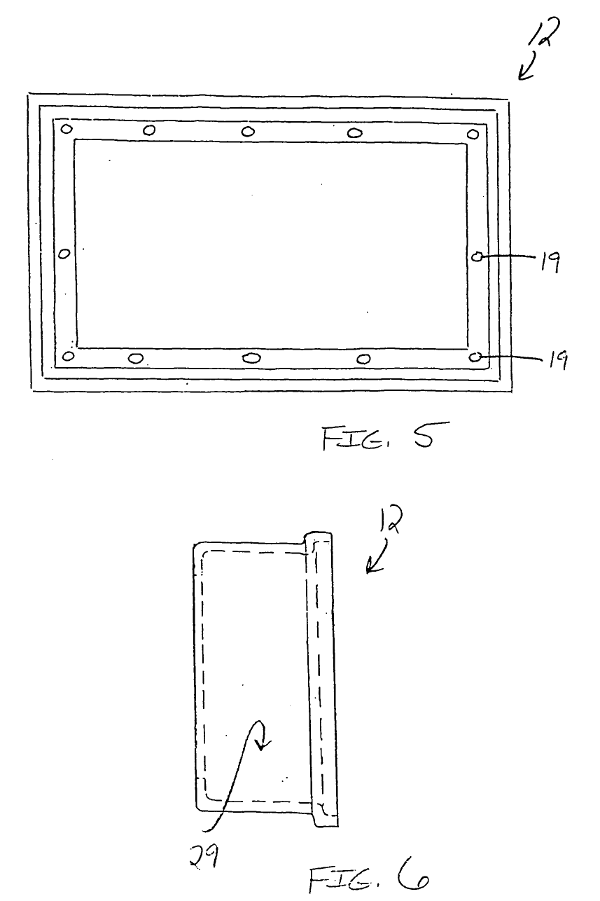

It is further contemplated that in one alternative embodiment, two-sided bread board type LED light panel 13 may be replaced by two bread board type LED panels 13(a), each of which may be attached to the alternative traffic control sign assembly by being received in the space 29 of control console 12, which space 29 is generally referenced in FIGS. 6 and 14. From an inspection of FIG. 14, it will be seen that it is contemplated that silicone glue fastening means 25 may be sandwiched by light panel 13(a) and sign attachment structure 30 of each control console 12. It will thus be understood from an inspection of FIG. 14 that alternative sign 11(a) is mostly continuous, not comprising central opening 17, but perhaps comprising rivet-receiving structure 19 as may be further gleaned from an inspection of FIG. 14.

Further, as preliminarily addressed hereinabove, a preferred alternative embodiment of the present invention is generally illustrated in FIGS. 24-28, namely, a traffic control sign assembly 80 or vehicle signal light assembly. Traffic control sign assembly 80 differs from traffic control sign assembly 10 primarily in that the separately formed control console assembly (comprising two control consoles 12) of traffic control sign assembly 10 are made integral with the sign structure, which sign structure has been divided into two opposing pieces, each piece essentially comprising an integral control console. It is contemplated that two sign structures each formed with an integral control console as in traffic control sign assembly 80 may be less costly to manufacture than sign 11 and two control consoles 12 to from traffic control sign assembly 10. Further, it is contemplated that traffic control sign assembly 80 may be less weighty and thus require less force to support for the benefit of oncoming traffic and the like.

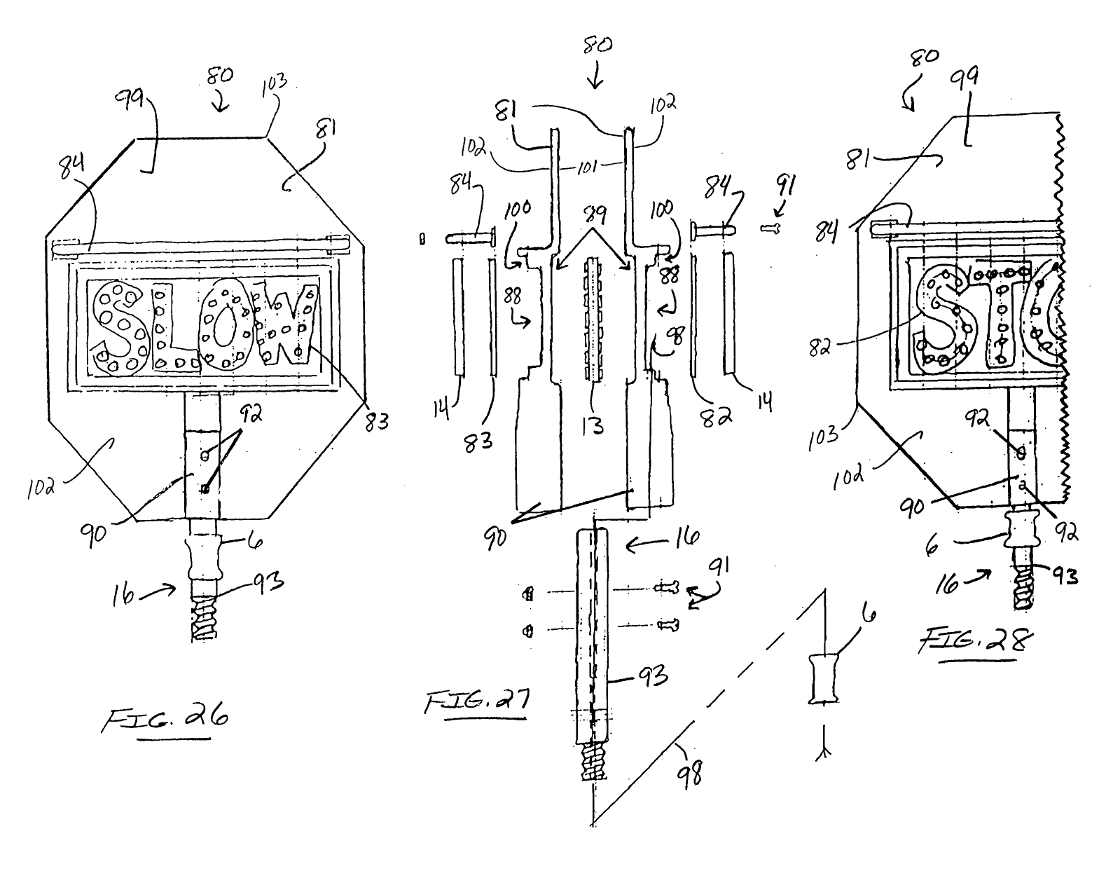

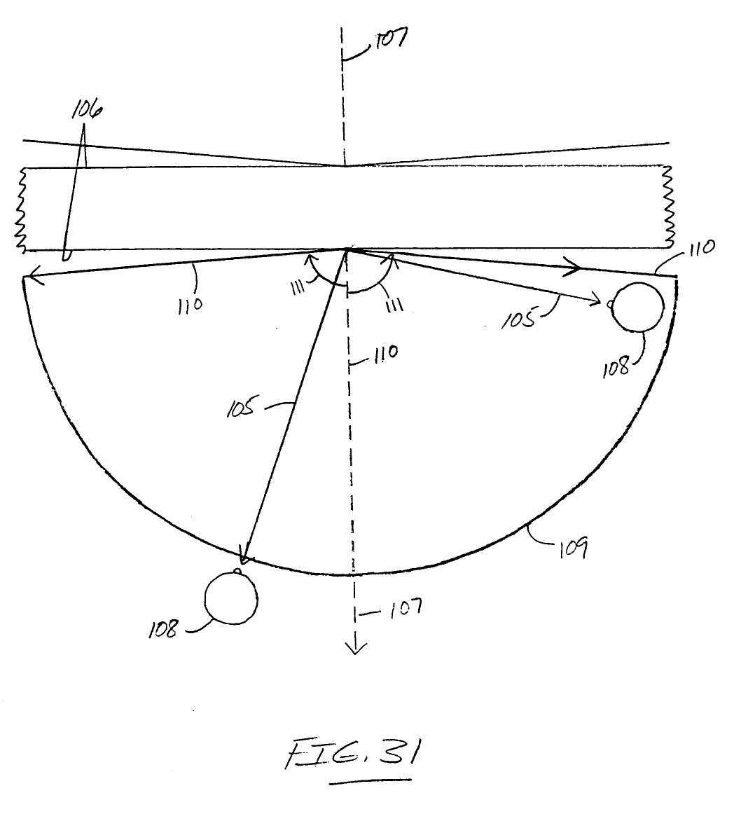

Thus, it will be seen that two-sided traffic control sign assembly 80 preferably comprises two opposing sign structures 81 as is illustrated and referenced in FIGS. 24-28; two-sided bread board type LED light panel 13 (as further referenced in FIGS. 25 and 27); a first legend bearing screen 82 as illustrated and referenced in FIGS. 25, 27, and 28; a second legend bearing screen 83 as illustrated and referenced in FIGS. 25-27; light-diffusing (diffused or prismatic) panels 14 (as further referenced in FIGS. 24, 25, and 27); two opposing display guards 84 as illustrated and referenced in FIGS. 25-28; and a power source, such as batteries 15, as housed within a battery pack 85 (referenced in FIGS. 25 and 29), which battery pack 85 is receivable in a battery box 86 as referenced in FIG. 25. Traffic control sign assembly 80 further comprises handle assembly 16 as further referenced in FIGS. 24-28, and 30, which handle assembly preferably comprises hand grip 6 as further referenced in FIGS. 24-28. Further, certain means for connecting sign structures 81 to one another; for connecting display guards 84 to sign structures 81; and for connecting handle assembly 16 to sign structures 81 are contemplated. Certain switch means are further generally illustrated and referenced at 87 in FIGS. 25 and 30.

Each sign structure 81 preferably comprise a central opening 88 as generally referenced in FIGS. 25 and 27; an inner sign surface 101 as referenced in FIGS. 24, 25, and 27; and an outer sign surface 102 as referenced in FIGS. 24-28. It will be understood from an inspection of the noted figures that each central opening 88 is preferably defined by cooperative light panel-receiving frame structure(s) at the inner sign surfaces 101, and by cooperative diffusing panel-receiving frame structures(s) at the outer sign surfaces 102. It will be further understood from a consideration of the noted figures that legend-bearing screens or signs 82 and 83 as well as prismatic panels 14 are preferably positioned on opposing respective sides of each sign structure 81 and are preferably in centered relation to central opening 88. Light panel 13 is preferably mounted in central openings 88 in sandwiched relation between sign structures 81 as framed by the cooperative light panel-receiving frame structure(s).

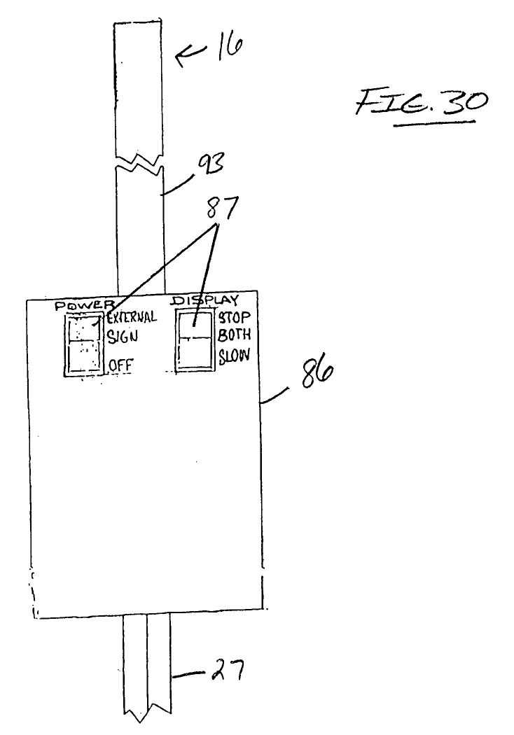

Each sign structure 81 may thus be said to comprise light panel-receiving frame structure or light panel-receiving means as will be seen from a general inspection of FIG. 27 at referenced numeral 89. Diffused or prismatic panels 14 are preferably mounted in each sign structure 81 in central alignment on opposing respective sides of sign structures 81 outwardly adjacent to legend-bearing signs 82 and 83 at the diffused panel-receiving frame structure(s) as referenced at 100. Diffused or prismatic panels 14 are fixedly received by diffused panel-receiving frame structure(s) and thus place hold legend-bearing screens or signs 82 and 83. Optionally, the outer surface 102 of each sign structure 81 may comprise prismatic reflective sheeting 99 adjacent to the outer sign perimeter 103 as referenced in FIGS. 24-26, and 28 (note: only a fragmentary perimeter 103 is shown in FIG. 28).

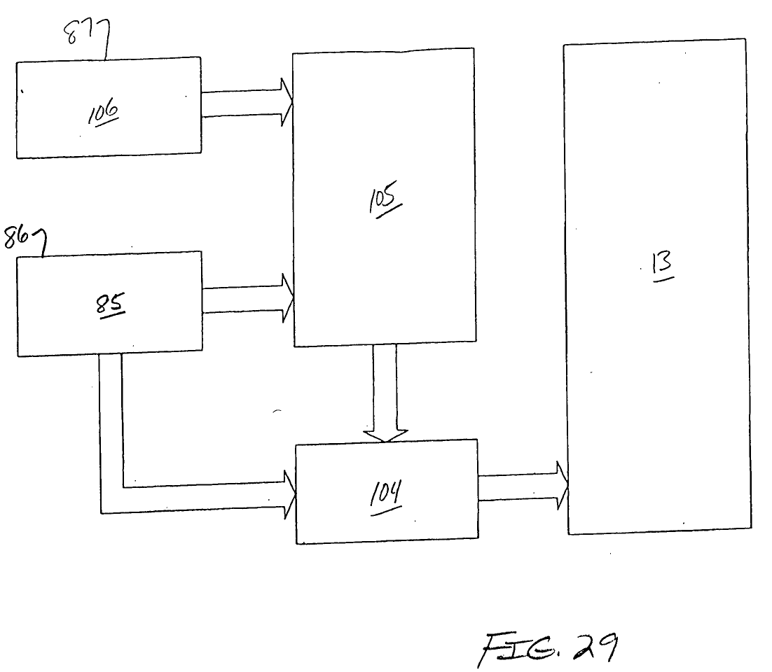

It will be further seen from an inspection of FIGS. 24-28 that each sign structure 81 comprises a handle-receiving structure 90 or handle-sandwiching means adjacent a bottom or inferior end of each sign structure 81. Handle-receiving structures 90 are integrally formed with the respective sign structure 81 in inferior adjacency to the respective central opening 88. Handle-receiving structures 90 are sized and shaped to receive the superior terminal portion of handle assembly 16 such that the superior terminal portion of handle assembly is sandwiched between sign structures 81. Certain fastening means or means for connecting handle assembly 16 to sign structures 81, such as nuts and bolts, function to fasten handle assembly 16 to sign structures 81 as generally depicted in FIG. 27 at 91. It will be seen from a further inspection of FIGS. 26 and 28 that certain fastener-receiving structures, such as bore apertures 92, are formed in each sign structure 81 for receiving the fastening means. Similarly, it will be further seen from an inspection of FIGS. 25 and 27 that certain fastening means function to connect display guards 84 to sign structures 81 In this regard, it is contemplated that nuts and bolts 91 function to fasten each display guard 84 to a respective sign structure 81. It is contemplated that display guards 84 may function to protect prismatic panels 14, legend-bearing signs 82 and 83, light panel 13, and certain superior areas of each sign structure 81 from damage, for example, if traffic control sign assembly 80 were dropped.

In the preferred alternative embodiment, batteries 15 are preferably mounted within battery pack 85 as housed within battery box 86 as generally depicted in FIGS. 25, 29, and 30. It is contemplated that battery box 86 is attached in inferior adjacency to hand grip 6 so as to make the assembled traffic control sign assembly 80 less top heavy. Thus, it will be seen from an inspection of FIGS. 25 and 30 that handle assembly 16 comprises electrical circuitry conduit 93 of a certain length to dispose battery box 86 in significant inferior adjacency thereto. Conduit 93 is further illustrated and referenced in FIGS. 26-28. FIGS. 26 and 28 show conduit 93 in an optional abbreviated length and FIG. 27 shows conduit 93 in a preferred elongate state. The inferior end of conduit 93 comprises means for connecting the same to battery box 86 as generally depicted in FIG. 25 at exploded view connecting line 94. Battery box 86 preferably comprises certain switch means 87 or selector switches; a low battery power alarm 95; a door 96 with latching handle 97 as referenced in FIG. 25; and means for receiving telescopic handle 27 as further referenced in FIGS. 25 and 30. The reader will recall the foregoing descriptions of telescopic handle 27 for detailed specifications thereof.

A wire harness electrically communicates the power source (such as batteries 15) located in battery box 86 to light panel 13 via battery box 86 and conduit 93. The wire harness is generally depicted in FIG. 27 at 98. The switch means, designed for turning batteries 15 “ON” in a holding or a flashing mode and for turning batteries 15 “OFF” have been generally referenced at 87 in FIGS. 25 and 30. A power source, such as batteries 15, are located in battery box 86 as previously specified and are connected to two-sided bread board type LED light panel 13 for providing electrical power to light two-sided bread board type LED light panel 13. It is contemplated that other power sources, such as solar power and external power, may be utilized to power certain electric circuitry contained in traffic control sign assembly 80.

FIG. 29 generally and diagrammatically depicts certain electrical circuitry of the preferred alternative embodiment of the traffic control sign assembly. Light panel 13 is generally referenced as being in electrical communication with a drive circuit 104, which circuit 104 is in electrical communication with both a power source (batteries 15 as collected in a battery pack 85 and as housed within battery box 86) and a control circuit 105. Control circuit 105 preferably comprises certain microprocessor based timers and the like. In electrical communication with the control circuit 105 are certain inputs 106 as selectively activated by the user via the switch means as referenced at numeral 87.

It is contemplated that traffic control sign assembly 80 may also provide means for converting and using power from a source such as the cigarette lighter of any vehicle (e.g. an emergency vehicle) using a standard power inverter or from an external battery pack, which pack may be included in a traffic control sign assembly kit, as previously described. In addition, the battery-powered power source can include battery packs (i.e. venus type) or the battery pack 85 can also be recharged whether by direct plug-in cord adaptor with standard voltage ratings or by removal of the battery pack from traffic control sign assembly 80 and placement on a standard charger.

It should be noted (by way of example) that the traffic control sign assembly 80 may be plugged into any of the following external power sources: any vehicular cigarette lighter (12V direct current) by utilizing a power converter assembly (provided separately or provided with the traffic control sign assembly kit); any vehicle with a generator (e.g. emergency vehicles) supplying alternate current by utilizing a power inverter assembly (provided separately or provided with the traffic control sign assembly kit); or a standard external battery pack for longer life of LED lights 22.

Similar to the preferred embodiment, the preferred alternative embodiment comprises legend-bearing screen or sign 82 (preferably a LEXAN type sign sheet) bearing the legend “STOP”, which legend appears directly behind or adjacent one of diffused or prismatic panels 14 and legend-bearing screen or sign 83 (preferably a LEXAN type sign sheet) bears the legend “STOP” or “SLOW”, which legend appears behind or adjacent to another of diffused or prismatic panels 14 mounted to sign structure 81. Lexan type sign materials are typically available in clear and opal versions and available on request in large quantities and in any colour and length. There is also a double-sided ultraviolet (UV) protected Lexan sheet for sign applications. This opal coloured (25% light transmission) Lexan version is given a UV coating on both sides during the production process.

Thus, traffic control sign assembly 80 preferably comprises sign structures 81 having central openings 88 that are defined by certain framework or frame structures. Sign structures 81 can be octagon shaped (as generally depicted in FIGS. 24-26, and 28), such as for a standard stop sign, as has been generally illustrated in the noted figures for ease of illustration, or sign structures 81 can be shaped as deemed necessary, it being noted that signs take on various shapes and sizes. In addition, sign structures 81 may also be painted with reflective paint or have reflective tape, such as glass bead type reflective tape, attached to its surface and edges to enhance the display of the message. Alternatively, as earlier stated, each sign structure may comprise prismatic reflective sheeting 99 to achieve a similar purpose. For example, a red color can be used for a “STOP” message and orange for “SLOW” and these colors can be painted to conform with standard shapes as used in traffic laws, such as octagonal for stop and triangular for yield and so forth.

It is contemplated that traffic control sign assembly 80 is constructed from these and other parts and is designed so as to be light-weight and the traffic control sign assembly 80 itself is intended to weigh approximately 5 pounds or less including batteries 15 and the like so that it may be easily held or supported by a person.

It will be recalled that FIG. 20(a) depicts a rendering of a “STOP-STOP” advisory; FIG. 20(b) depicts a rendering of a “STOP-SLOW” advisory; and FIG. 20(c) depicts a rendering of a “SLOW-SLOW” advisory, all of which advisories represent common or typical advisories. It will be seen from a comparative inspection of FIGS. 26 and 28 that legend-bearing sign 82 may comprise a “STOP” type advisory and legend-bearing sign 83 may comprise a “SLOW” type advisory. It is contemplated that other advisories may easily be rendered upon the sign with appropriate adjustments.

It will be seen from an inspection of FIG. 25 that diffused or prismatic panels 14 and legend-bearing signs 82 and 83 are preferably mounted in the respective sign structure 81 such that diffusing panel receiving means or a sign/panel-receiving structure 100 receives the same. Prismatic panels and legend-bearing signs 82 and 83 are thus received in central alignment on opposite sides of each central opening 88. It will be recalled that diffused or prismatic panels 14 are preferably prismatic, meaning that they spread or diffuse light energy. Diffused or prismatic panels 14 thus preferably provide a cover for one side of the respective legend-bearing sign and two-sided bread board type LED light panel 13.

Thus, it will be noted that in the preferred alternative embodiment, legend-bearing sign 82 bears the legend “STOP” and is located on the back of one of diffused or prismatic panels 14; further, legend-bearing sign 83 bears the either the legend “STOP” or the legend “SLOW” and is located on the back of the other of diffused or prismatic panels 14. These legends are then aligned with LED lights 22 so that the spread of the light thereby increases the brightness and clarity of the message. The alignment and usage of the diffused (prismatic) panels 14 increases the distance from which the message can be read over ¼ mile from traffic control sign assembly 80 and the angle of view of light panel 13 so that the message can be read from up to a 170 degree line of sight from the center of sign structures 81. In other words, given prismatic light-diffusing panels, viewers 108 may effectively view a traffic control message as indicated or depicted with a light ray 105 in FIG. 31 at a distance of at least ¼ mile away from the light-emitting surface 106 of traffic control sign assembly 80 without obstructions intermediate the sign assembly 80 and the viewer 108.

From an inspection of FIG. 31, it will be understood that the diagrammatic figures is not to scale and exaggerated for effect. Thus, the radius 110 of the sectioned circle depicted at 109 in FIG. 31 should be read to have a measured magnitude of ¼ mile (1,320 feet). Further, viewers 108 may view the message 105 emanating from light panel 13 and diffused at the light-emitting surface 106 up to 85 rotational degrees (as depicted at 111) on either side of a light diffusion axis 107 (assuming a horizontal viewing plane) extending perpendicular through the center of the traffic control sign assembly 80 or vehicle signal light assembly 80. A circle with radius of 1,320 feet will occupy approximately 5.47 million square feet. The section of circle depicted at 109 will thus occupy approximately 2.58 million square feet and thus the viewing range for traffic control sign assembly 80 (and 10) is at least on the order of 2.5 million square feet.

The ability to read the message from practically any orientation of traffic control sign assembly 80 dramatically increases the effectiveness of traffic control sign assembly 80 and practically overcomes any error in orientation of traffic control sign assembly 80 in the field, such as when the holder has accidentally turned planar portions of traffic control sign assembly 80 somewhat away from oncoming traffic. As discussed above, the messages on both sides of traffic control sign assembly 80 can then be read and understood at nearly all angles and from a large distance, thus improving protection of both the reader and the holder and people at the site at issue. Diffused or prismatic panels 14 are preferably constructed from phenolic type material (i.e. a type of reflective sheet covering) including pyramid type cones (i.e. dimpled) upon a surface thereof to deflect the light in all directions and to spread the light to enhance and equalize the brightness within the “pixel-looking” circles.

An additional significant feature of the present invention, as generally referenced in FIGS. 9-12, 15, and 15(a), is handle assembly 16. Handle assembly 16 is preferably secured to sign 11 for enabling traffic control sign assembly 80 to be hand held by a person, in a preferred embodiment. Handle assembly 16 preferably includes different embodiments including a telescoping handle 27 as illustrated and referenced in FIGS. 15, 15(a), 25, and 30. Handle 27 preferably comprises screw means for screwed-in attachment and detachment means, a collapsible tripod embodiment for hands-free use, a modular or multi-sectioned handle that has screw attachment means, and a weighted base self-supporting stanchion embodiment that rests upon the ground. Handle assembly 16 may further preferably comprise a slide-on grip 28 as illustrated and referenced in FIGS. 9, 10, 11, 15, and 15(a) and telescoping handle 27 can extend traffic control sign assembly 10 to over 6 feet high for better message visibility. Handle assembly 16 may preferably be constructed from wood, plastic, or metal materials, and may be slotted so as to be received and yoked or interlocked with the sign. It should be noted that handle assembly 16 should be of sufficient weight so that traffic control sign assembly 80, in total, weigh approximately 5 pounds or less. Although not shown, other usages contemplated for the sign can include attachment to vehicles, such as school buses.

Further, it is contemplated that a hands-free, stand-mounted traffic control sign assembly 50 (as may be seen from an inspection of FIG. 21) may enable the user to temporarily situate the sign assembly so that the user may be free to perform other activities (other than holding sign assembly 80). From an inspection of FIG. 21, it will be seen that stand-mounted traffic control sign assembly 50 preferably comprises a threaded sleeve 51; a locking knob 52; a tripod or four-legged stand 53; and a telescoping pole 54. Threaded sleeve 51 threads up onto base of the handle. The tripod or four-legged stand 53 may preferably comprise foldable legs 55 for portability. Telescoping pole 54 is designed for height adjustment as does locking knob 52. Note that the same telescoping pole may be utilized for the hand-held traffic control sign assembly or the stand-mounted traffic control sign assembly. With regard to the hand-held version, it is contemplated that a grip 6 (as referenced in FIGS. 1 and 22) may be utilized in combination with handle assembly 16 to provide the holder with more comfortable structure with which to grasp and hold traffic control sign assembly 10.

In construction and in use the present invention therefore provides traffic control sign assembly 80 that provides enhanced visual clarity, brightness, and coverage including distances of at least ¼ mile and at nearly any angle from which traffic control sign assembly 80 can be turned. Traffic control sign assembly 80 is highly visible, distinctly displays the appropriate warning messages, is capable of quickly being powered by various means, and is sturdy, lightweight, adaptable to different sites and under different working conditions, and is easy to use and manufacture.

While the above description contains much specificity, this specificity should not be construed as limitations on the scope of the invention, but rather as an exemplification of the invention. For example, it is believed that the spirit of the present invention teaches a traffic control sign assembly, which assembly essentially comprises first and second opposing sign structures, at least one bread board type LED light panel, first and second light-diffusing panels, batteries, attachment means, first and second legend-bearing screens, switch means, and a handle assembly. The sign structures each comprise an outer sign surface, light panel-receiving means, diffusing panel-receiving means, handle-sandwiching means, and an outer sign perimeter. The light panel is preferably positioned intermediate the sign structures in centered relation to the outer sign perimeters, the light panel being received by the light panel-receiving means. The light-diffusing panels are received by the diffusing panel-receiving means in central alignment on opposite sides of the light panel, the legend-bearing screens being sandwiched intermediate the diffusing panel-receiving means at the outer sign surface and the light-diffusing panels. The batteries are mounted in inferior adjacency to the light panel and in electrical communication with the light panel for providing electrical power for the light panel. This arrangement helps offset the weight of the upper sign assembly so that the resulting assembly is not as top heavy. The attachment means function to connect the sign structures to each other in unitary assembly.

The first legend-bearing screen with legend “STOP” is cooperatively associated with the first light-diffusing panel as received in the first sign structure and the second legend-bearing sign with legend “STOP” or “SLOW” is cooperatively associated with the second light-diffusing panel as received in the second sign structure. In other words, the first legend-bearing screen bears a first traffic legend adjacent the first light-diffusing panel and the second legend-bearing screen bears a select traffic legend adjacent the second light-diffusing panel, the select traffic legend being selected from the group consisting of the first traffic legend and a second traffic legend.

The switch means enable the batteries to power the light panel. The handle assembly is sandwiched intermediate the handle-sandwiching means, and thus, is secured to the sign structures for enabling the vehicle signal light assembly to be hand held by a person. The light panel means are thus cooperatively associated with the sign structures for providing light and for directing the provided light away from the plane in which the sign substantially lies. The light diffusion means are also cooperatively associated with the sign structures, which means are designed to diffuse the provided light away from and substantially parallel (up to about 85 rotational degrees on either side of an axis extending perpendicularly through the center of the sign). The power source is in electrical communication with the light panel means for electrically powering the light panel means. It is further contemplated that the traffic control sign assembly may comprise sign display means (such as the handle assembly) for otherwise supporting the sign, the supported sign for displaying visual messages to approaching viewers or passersby.

Essentially, a traffic control sign assembly is taught comprising opposing sign structures, light panel means, light diffusion means, connecting means, and a power source. Each opposing sign structure comprises an outer sign surface and an outer sign perimeter, the outer sign surface adjacent the outer sign perimeters being substantially planar. The light panel means are cooperatively associated with the sign structures centrally located relative to the outer sign perimeters. The outer sign perimeters are concentric about a light diffusion axis. The light panel means provide light, which is directed away from the sign structures.

The light diffusion means are cooperatively associated with the sign structures and the light panel means diffusing the light substantially parallel to the outer sign surface adjacent the outer sign perimeters. In this regard, it is contemplated that the light-diffusing means enable viewing of the illuminated visual messages up to 85 rotational degrees from the light diffusion axis. The connecting means connect the sign structures, the light panel means, and light diffusion means to each other in unitary assembly. Finally, the power source is in electrical communication with the light panel means for selectively electrically powering the light panel means.

Optionally, the traffic control assembly may comprise legend-bearing means, which are received intermediate the light panel means and the light diffusion means. The legend-bearing means enable display of legend-reinforced, illuminated visual messages to approaching viewers. The traffic control sign assembly may further comprise sign display means for supporting the sign structures, the supported sign structures for displaying elevated illuminated visual messages to approaching viewers.

Thus, as various possible embodiments may be made in the above invention for use for different purposes and as various changes might be made in the embodiments and methods above set forth, it is understood that all of the above matters here set forth or shown in the accompanying drawings are to be interpreted as illustrative and not in a limiting sense.

We claim:

1. A vehicle signal light assembly, the vehicle signal light comprising, in combination, first and second opposing sign structures, at least one bread board type LED light panel, first and second light-diffusing panels, a power source, attachment means, first and second legend-bearing screens, switch means, and a handle assembly, the sign structures each comprising an outer sign surface, light panel-receiving means, diffusing panel-receiving means, handle-sandwiching means, and an outer sign perimeter, the light panel being positioned intermediate the sign structures in centered relation to the outer sign perimeters, the light panel being received by the light panel-receiving means, the light-diffusing panels being received by the diffusing panel-receiving means in central alignment on opposite sides of the light panel, the legend-bearing screens being sandwiched intermediate the diffusing panel-receiving means and the light-diffusing panels, the power source being spatially located in inferior adjacency to the light panel and in electrical communication therewith for providing electrical power to the light panel, the attachment means connecting the sign structures to each other in unitary assembly, the first legend-bearing screen with legend “STOP” being cooperatively associated with the first light-diffusing panel as received in the first sign structure, the second legend-bearing sign with legend “STOP” or “SLOW” being cooperatively associated with the second light-diffusing panel as received in the second sign structure, the switch means for enabling the power source to selectively power the light panel, the handle assembly being sandwiched intermediate the handle-sandwiching means, the handle assembly thus being secured to the sign structures for enabling the vehicle signal light assembly to be hand held by a person.

2. The vehicle signal light assembly of claim 1 comprising a collapsible tripod connected to the handle assembly for hands-free use.

3. The vehicle signal light assembly of claim 1 comprising a telescopic handle, the telescopic handle having screw means for screwed-in attachment and detachment from the handle assembly.

4. The vehicle signal light assembly of claim 1 wherein the first and second light-diffusing panels are prismatic, the first and second prismatic light-diffusing panels enabling viewing of the light panel up to 85 rotational degrees on either side of an axis extending perpendicular through the center of the vehicle signal light assembly.

5. The vehicle signal light assembly of claim 4 wherein oncoming traffic is able to view the vehicle signal light assembly from a distance of at least ¼ mile from the vehicle signal light assembly.

6. The vehicle signal light assembly of claim 1 wherein the vehicle signal light assembly is lightweight, the lightweight vehicle signal light assembly weighing 5 pounds or less.

7. The vehicle signal light assembly of claim 1 wherein the light-diffusing panels are constructed from phenolic type material, the phenolic type material comprising pyramid type cones and pixel type circles upon a surface thereof, the pyramid type cones for deflecting light to enhance illumination of the pixel type circles.

8. The vehicle signal light assembly of claim 1, wherein the attachment means for connecting the sign structures to one another in unitary assembly comprises silicone adhesive, the silicone adhesive for preventing damage to components experiencing rapid accelerative forces and for enabling use of the vehicle signal light assembly in all weather conditions.

9. The vehicle signal light assembly of claim 1 wherein the outer sign surfaces comprise prismatic reflective sheeting, the prismatic reflective sheeting for enhancing visibility of the vehicle signal light assembly.

10. A selectively supportable vehicle signal light assembly, the vehicle signal light assembly comprising:
a pair of opposing sign structures, the sign structures each comprising an outer sign perimeter, light panel-receiving means, and diffusing panel-receiving means, the outer sign perimeters each being similarly sized and shaped and having a central opening adjacent the light panel-receiving means;
a two-sided bread board type LED light panel received by the light panel-receiving means adjacent the central openings;
a pair of light-diffusing panels, the light-diffusing panels being received by the diffusing panel-receiving means on opposite sides of the light panel opposite the central openings;
a power source, the power source being spatially located in inferior adjacency to the light panel and in electrical communication therewith for providing electrical power to the light panel;
means connecting the sign structures to one another in unitary assembly; and
switch means for selectively enabling power delivery to the light panel.

11 The vehicle signal light assembly of claim 10 comprising first and second legend-bearing screens, the first legend-bearing screen bearing a first traffic legend adjacent the first light-diffusing panel, the second legend-bearing screen bearing a select traffic legend adjacent the second light-diffusing panel, the select traffic legend being selected from the group consisting of the first traffic legend and a second traffic legend.

12. The vehicle signal light assembly of claim 11 selectively supported by a tripod, the tripod being cooperatively associated with at least one outer sign perimeter for enabling hands-free use of the vehicle signal light assembly.

13. The vehicle signal light assembly of claim 11 selectively supported by a telescopic handle assembly, the telescopic handle assembly being cooperatively associated with at least one outer sign perimeter for selectively elevating the vehicle signal light assembly.

14. The vehicle signal light assembly of claim 13 wherein the vehicle signal light assembly is lightweight, the lightweight vehicle signal light weighing less than about 5 pounds.

15. The vehicle signal light assembly of claim 10 wherein the light-diffusing panels are prismatic, the prismatic light-diffusing panels enabling viewing of the light panel up to 85 rotational degrees from an axis extending perpendicular through the center of the vehicle signal light assembly.

16. The vehicle signal light assembly of claim 15 wherein oncoming traffic is able to see the vehicle signal light assembly from a distance of at least ¼ mile to provide enhanced user safety.

17. The vehicle signal light assembly of claim 16 wherein the switch means enable the light panel to provide two modes of illuminated signals, the two modes including a constant signal mode and a flashing signal mode.

18. The vehicle signal light assembly of claim 17 wherein prismatic reflective sheeting is attached to each sign structure in adjacency to the outer perimeter thereof for enhancing visibility of the vehicle signal light assembly.

19. A traffic control sign assembly, the traffic control sign assembly comprising:
opposing sign structures, each opposing sign structures comprising an outer sign surface and an outer sign perimeter, the outer sign surface adjacent the outer sign perimeters being substantially planar;
light panel means, the light panel means being cooperatively associated with the sign structures centrally located relative to the outer sign perimeters, the outer sign perimeters being concentric about a light diffusion axis, the light panel means for providing light, the light being directed away from the sign structures;
light diffusion means, the light diffusion means being cooperatively associated with the sign structures and the light panel means, the light diffusion means for diffusing the light substantially parallel to the outer sign surface adjacent the outer sign perimeters;
means connecting the sign structures, the light panel means, and light diffusion means to each other in unitary assembly; and
a power source, the power source being in electrical communication with the light panel means for electrically powering the light panel means.

20. The vehicle signal light assembly of claim 19 wherein the light-diffusing means enable viewing of the illuminated visual messages up to 85 rotational degrees from the light diffusion axis.

21. The traffic control assembly of claim 20 comprising legend-bearing means, the legend-bearing means being received intermediate the light panel means and the light diffusion means, the legend-bearing means enabling display of legend-reinforced, illuminated visual messages to approaching viewers.

22. The traffic control sign assembly of claim 21 wherein the traffic control sign assembly comprises sign display means, the sign display means for supporting the sign structures, the supported sign structures for displaying elevated illuminated visual messages to approaching viewers.
